(19) United States
(12) Patent Application Publication
(10) Pub. No.: US 2006/0080433 A1
(43) Pub. Date: Apr. 13, 2006

(54) Method and system for delivering information with optimized pre-fetching

(76) Inventors: Umberto Caselli, Roma (IT); Scot MacLellan, Roma (IT)

Correspondence Address: IBM CORPORATION;INTELLECTUAL PROPERTY LAW, 11400 BURNET ROAD, AUSTIN, TX, 78758, US

(21) Appl. No.: 11/272,516

(22) Filed: Nov. 10, 2005

(30) Foreign Application Priority Data
Oct. 11, 2004 (EP) 04105663.1

(51) Int. Cl. G06F 15/173

(52) U.S. Cl. 709/224

(57) ABSTRACT

A method (300) for delivering monitoring data is proposed. The monitoring data is collected on a central server from selected managed computers, in order to be provided to multiple clients (in response to periodic requests). In the method of the invention, for each managed computer the central server estimates (336;351-354) an expected duration of a next collection of the monitoring data (according to the duration of one or more preceding collections). A trigger delay of the next collection is then calculated by subtracting (366) a time advance to the expected time of the next request (defined by the corresponding period); the time advance is based (339-348;357;363) on the expected duration of the next collection, suitably incremented by a safety margin (so as to prevent receiving the next request before the corresponding collection has completed). The monitoring data is then pre-fetched (315-324) from the managed computer when the trigger delay expires.

### TECHNICAL FIELD

The present invention relates to the data processing field. More specifically, the present invention relates to a method for delivering information in a data processing system. The invention further relates to a computer program for performing the method, and to a product embodying the program. Moreover, the invention also relates to a corresponding data processing system, and to a data processing infrastructure including this system.

### BACKGROUND ART

Data processing infrastructures are routinely used to deliver information in interactive applications (wherein the information is typically displayed on a monitor in real-time). Particularly, in an infrastructure with distributed architecture the required information can be provided by one or more remote sources. In this case, the information must be collected on a central server (from the different sources) before it can be delivered to the corresponding users. A typical example is that of a monitoring application (such as “IBM Tivoli Monitoring, or ITM”), wherein monitoring data indicative of the performance of different managed computers is measured on each one of them; the monitoring data is then collected on the central server and delivered to an operator periodically. The periodic refresh of the monitoring data allows the operator to have constant updates of the health and performance of the infrastructure; for example, this information is used to detect any critical condition of the managed computers (and possibly to take corresponding correction actions).

A problem of the above-described infrastructure is that of ensuring the currency of the information that is delivered to the users. A typical solution for having the infrastructure deliver the most recent information consists of triggering its collection from the respective sources synchronously (i.e., when a corresponding request is received from each user). A drawback of this approach is that the request cannot be satisfied until the collection of the requested information has been completed; this results in a substantial waiting time for the user (which is very frustrating and untenable in many practical situations).

Another problem then arises from the need of proving an acceptable response time for the users. A solution known in the art for optimizing the responsiveness of the infrastructure is that of collecting the information asynchronously; the information is then pre-fetched and stored temporarily into a cache memory, so as to be immediately available when it is requested. However, with this approach the user receives the information as it was when collected from the corresponding sources (ahead of the actual request); therefore, the information may not be valid any longer (with the risk of causing wrong decisions).

### SUMMARY OF THE INVENTION

According to the present invention, the idea of synchronizing the collection of the information with its requests is suggested.

Particularly, an aspect of the invention provides a method for delivering information in a data processing system in response to repeated requests; the information is collected from one or more source entities, each one providing a corresponding type of information. The method involves the following steps for each source entity. Firstly, an expected request time of a next request of the corresponding information is determined (according to the request time of one or more preceding requests); moreover, an expected collection duration of a next collection of the information from the source entity is also determined (according to the collection duration of one or more preceding collections). The information can then be collected ahead of the next request, according to the expected request time and the expected collection duration.

The proposed solution balances the opposed requirements of having both a high currency of the information and a low response time of the infrastructure (as experienced by the corresponding users).

Particularly, the devised method decouples the collection of the information from its requests. In this way, it is possible to have the collection of the information completed as close as possible to the receiving of the corresponding request.

As a result, the information can be delivered with a very fast response time; at the same time, the age of the retrieved information can be reduced to a very low value.

The different embodiments of the invention described in the following provide additional advantages.

For example, without detracting from its general applicability, the requests have a predefined period; in this case, the collection is started at the expiry of a trigger time that precedes the known time of the next request by a time advance based on the expected collection duration.

This solution can be applied in many practical situations with a very simple implementation.

In a specific embodiment of the invention, the expected collection duration is set to the collection duration of the preceding collection; the time advance is then determined by adding a safety margin (calculated multiplying the expected collection duration by a correction factor) to the expected collection duration.

The proposed algorithm ensures (with an acceptable degree of confidence) that the collection has completed before receiving the next request (for example, when the collection durations do not exhibit significant fluctuations); moreover, this result is achieved with a very low computation complexity.

A suggested choice for the correction factor is between 0.5 and 1.5.

This value is a good compromise between the opposed requirements of high currency of the information and low risk of receiving the next request before its collection has completed.

A way to further improve the solution is to set a minimum value for the safety margin in any case.

The suggested solution can prevent the above-mentioned problem when the collection durations vary and can increase significantly from one period to the next.

Advantageously, the minimum value is equal to a predetermined percentage of the period.

As a result, the algorithm self-adapts to different operative environments.

In a more sophisticated embodiment of the invention, the expected collection duration is calculated as the mean value of the collection durations of a set of preceding collections; the time advance is then determined by adding a further safety margin (obtained multiplying the corresponding standard deviation by a further correction factor) to the expected collection duration.

In this way, the risk of receiving the next retrieve request before the collection has completed is strongly reduced (but at the cost of an increased computational complexity).

Preferably, the number of preceding collections is between 5 and 15.

The chosen value is effective in both filtering out peak values of the collection durations and responding quickly to significant changes thereof.

A suggested choice for the further correction factor is between 1 and 3.

This value provides good results (i.e., high currency of the information and low risk of receiving the next request before its collection has completed) in most practical situations.

Without detracting from its general applicability, the proposed solution has been specifically designed for delivering monitoring data.

A further aspect of the present invention provides a computer program for performing the above-described method.

A still further aspect of the invention provides a program product embodying this computer program.

Another aspect of the invention provides a corresponding data processing system.

Moreover, a different aspect of the invention provides a data processing infrastructure including this system.

The characterizing features of the present invention are set forth in the appended claims. The invention itself, however, as well as further features and advantages thereof will be best understood by reference to the following detailed description, given purely by way of a nonrestrictive indication, to be read in conjunction with the accompanying drawings.

### BRIEF DESCRIPTION OF THE DRAWINGS

FIG. 1a is a schematic block diagram of a data processing infrastructure in which the method of the invention is applicable;

FIG. 1b shows the functional blocks of a generic computer of the infrastructure;

FIG. 2 depicts the main software components that can be used for practicing the method;

FIGS. 3a-3c show a diagram describing the flow of activities relating to an illustrative implementation of the method; and

FIGS. 4a-4b are timing diagrams of exemplary operations carried out in the infrastructure.

### DETAILED DESCRIPTION OF THE PREFERRED EMBODIMENT(S)

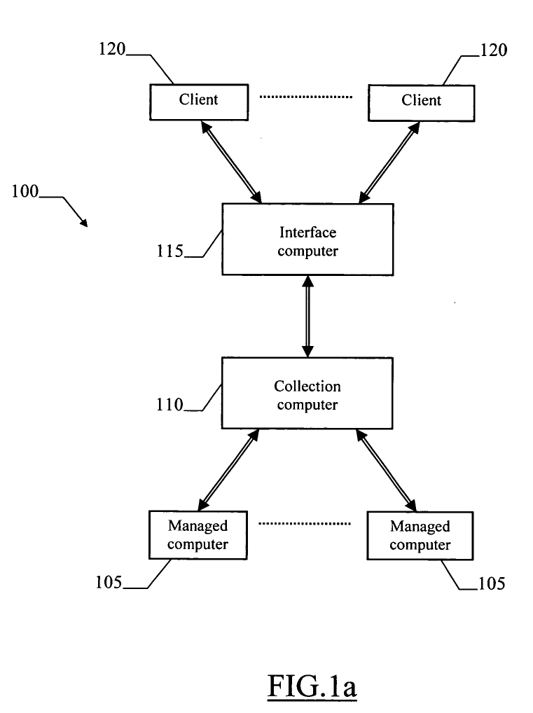

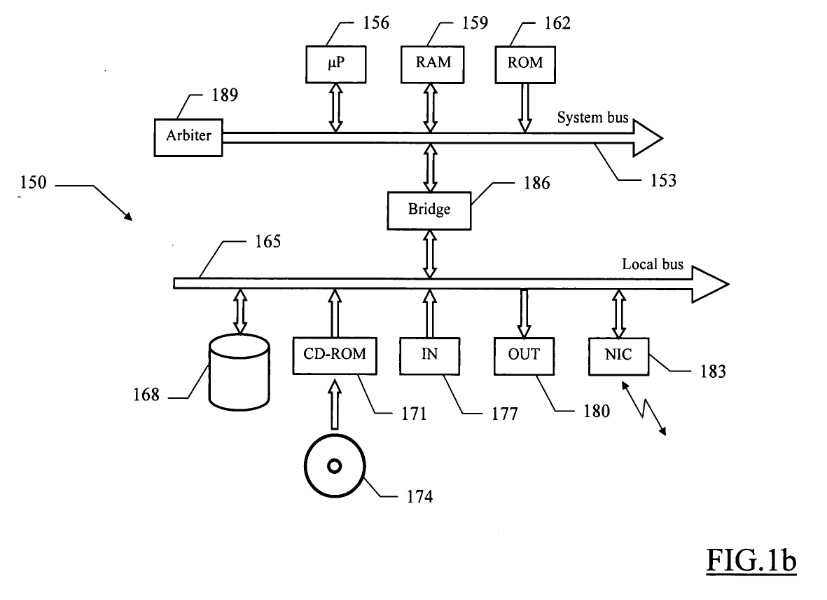

With reference in particular to FIG. 1a, a data processing infrastructure 100 with distributed architecture is illustrated. The infrastructure 100 runs a monitoring application, which is used to trace operation of multiple managed computers 105. For this purpose, corresponding monitoring data provided by the managed computers 105 is collected on a central computer 110. The collection computer 110 communicates with an interface computer 115. The interface computer 115 delivers the monitoring data to multiple client computers 120. Typically, the monitoring data provided to each client 120 is displayed on a console of an operator; in this way, the operator can monitor the health and performance of the infrastructure 100.

As shown in FIG. 1b, a generic computer of the infrastructure (managed computer, collection computer, interface computer, or client) is denoted with 150. The computer 150 is formed by several units that are connected in parallel to a system bus 153. In detail, one or more microprocessors (μP) 156 control operation of the computer 150; a RAM 159 is directly used as a working memory by the microprocessors 156, and a ROM 162 stores basic code for a bootstrap of the computer 150. Peripheral units are clustered around a local bus 165 (by means of respective interfaces) Particularly, a mass memory consists of a hard disk 168 and a drive 171 for reading CD-ROMs 174. Moreover, the computer 150 includes input devices 177 (for example, a keyboard and a mouse), and output devices 180 (for example, a monitor and a printer). A Network Interface Card (NIC) 183 is used to connect the computer 150 to a network. A bridge unit 186 interfaces the system bus 153 with the local bus 165. Each microprocessor 156 and the bridge unit 186 can operate as master agents requesting an access to the system bus 153 for transmitting information. An arbiter 189 manages the granting of the access with mutual exclusion to the system bus 153.

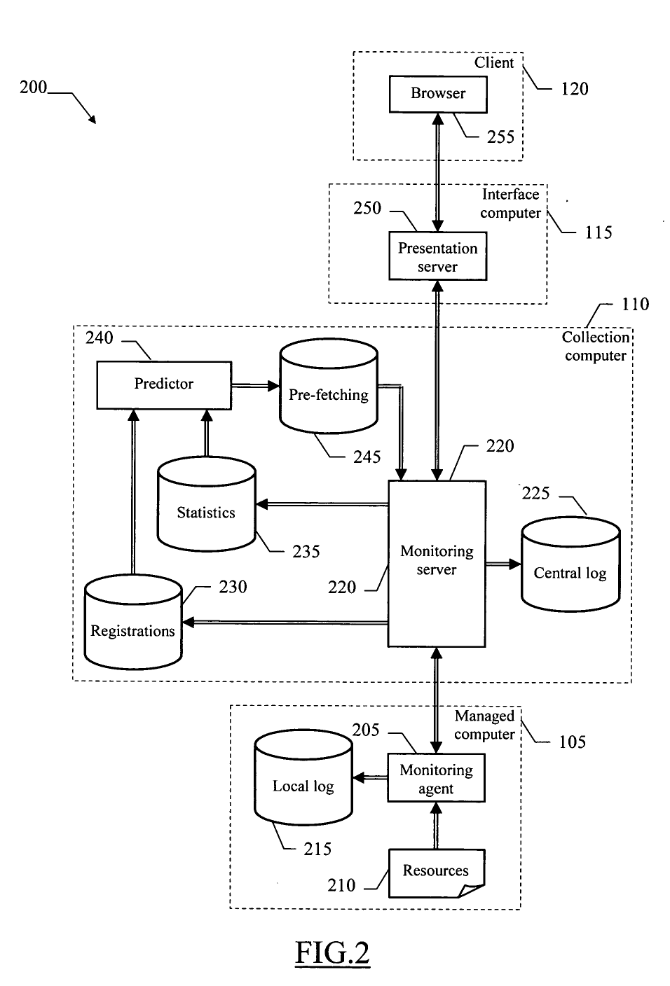

Moving now to FIG. 2, the main software components that can be used for practicing the invention are denoted as a whole with the reference 200. The information (programs and data) is typically stored on the hard disks and loaded (at least partially) into the corresponding working memories when the programs are running. The programs are initially installed onto the hard disks from CD-ROMs.

Considering in particular a generic managed computer 105, a monitoring agent 205 measures performance parameters of different hardware and/or software resources 210 of the managed computer 105 (for example, a processing power consumption, a memory space usage, a bandwidth occupation, and the like). The monitoring data derived from those performance parameters (either directly or after an analysis thereof) is stored into a local log 215.

The monitoring data is then transmitted from the monitoring agent 205 to a monitoring server 220 running on the collection computer 110. The monitoring agent 205 and the monitoring server 220 operate according to a pull paradigm (wherein the monitoring data is collected on-demand); for this purpose, the monitoring agent 205 measures and returns the monitoring data in response to a corresponding collection request received from the monitoring server 220. The monitoring data collected by the monitoring server 220 (from the different managed computers of the infrastructure) is stored into a central log 225.

The monitoring server 220 maintains a registration database 230 of the clients. The registered clients periodically send requests for retrieving desired monitoring data to the collection computer 110; for each client, the registration database 230 stores an indication of the managed computers to be monitored, of the monitoring data to be collected, and of the period of the corresponding retrieve requests (for example, of the order of some tens of seconds in many practical applications). Statistics relating to the preceding collections of the monitoring data from the corresponding managed computers are logged into a further database 235; particularly, for each client the statistics database 235 stores the duration of one or more of the preceding collections of the monitoring data from each relevant managed computer.

A predictor 240 accesses the registration database 230 and the statistics database 235. As described in detail in the following, for each pair client/managed computer the predictor 240 estimates a trigger delay of a next collection of the corresponding monitoring data (with respect to a last retrieve request). The trigger delay is set so as to have the collection request precede an expected time of the next retrieve request by a desired time advance. The expected time of the next retrieve request is simply determined by considering that is should be received with a delay equal to the corresponding period (with respect to the last retrieve request). On the other hand, the time advance is determined with the object of completing the collection of the monitoring data immediately before receiving the next retrieve request. For this purpose, the predictor 240 determines an expected duration of the next collection (according to the duration of the preceding collections stored in the statistics database 235); the time advance is based on the expected collection duration, suitably incremented by a safety margin so as to prevent receiving the next retrieve request before the collection of the desired monitoring data has completed. This information (which allows optimizing a pre-fetching of the monitoring data) is stored into a corresponding database 245. The pre-fetching database 245 is accessed by the monitoring server 220, which submits the collection requests to the managed computers accordingly.

The monitoring server 220 communicates with a presentation server 250 running on the interface computer 115. The presentation server 250 exposes a web interface, which is accessed by each client 120 through a corresponding browser 255. The presentation server 250 bridges between the browser 255 and the monitoring server 220; particularly, the presentation server 250 allows the client 120 to submit the retrieve requests to the collection computer 110 and to receive the corresponding monitoring data.

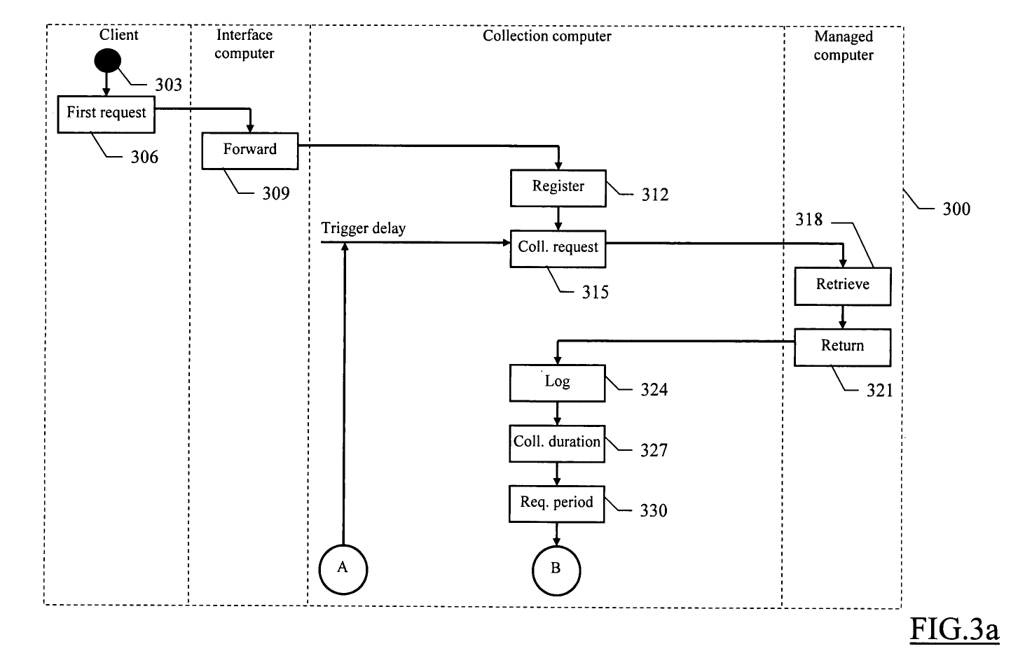

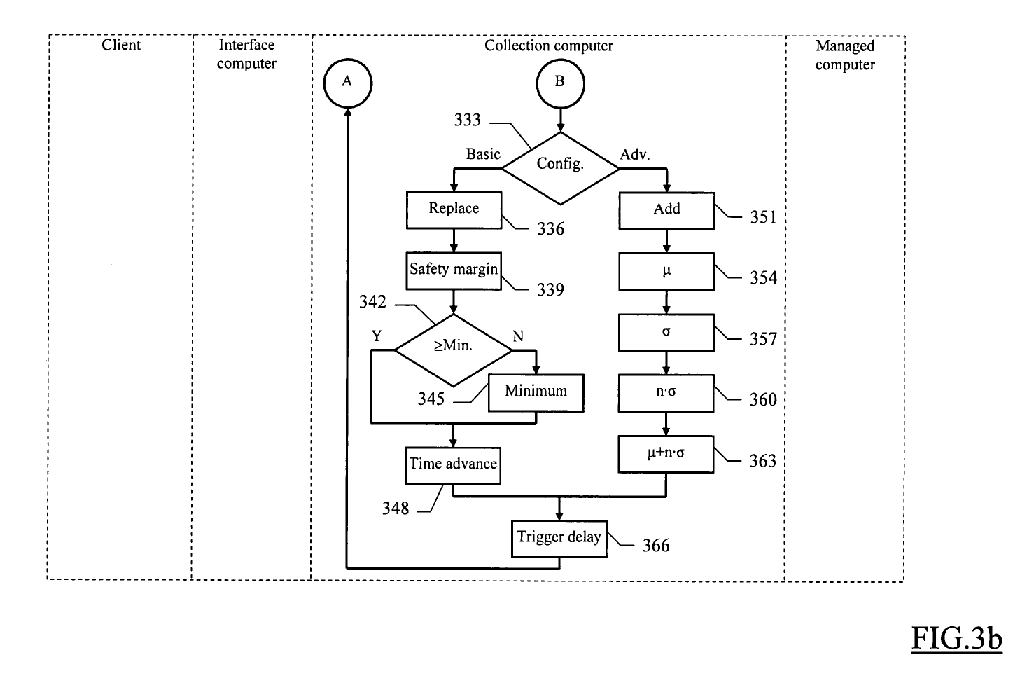

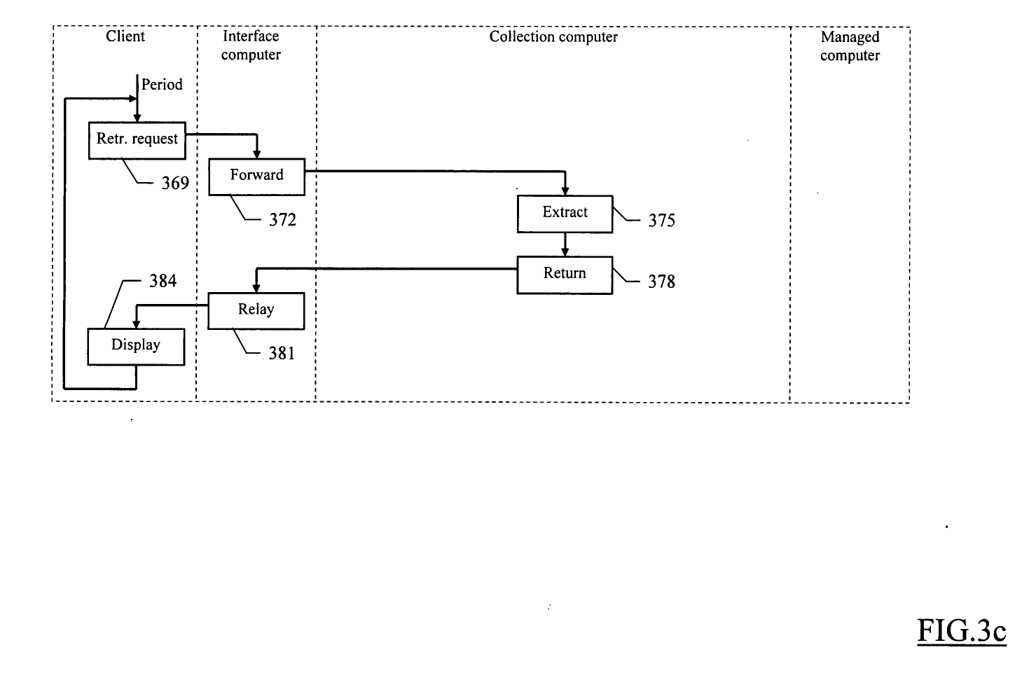

Considering now FIGS. 3a-3c, the logic flow of a monitoring process according to an embodiment of the invention is represented with a method 300. The method begins at the black start circle 303 in the swim-lane of a generic client; it should be noted that the above-described infrastructure manages the different clients individually (so that they are completely opaque to each other).

Passing to block 306, the monitoring process is enabled by the client submitting a first retrieve request to the interface computer; the first retrieve request specifies the involved managed computers, the desired monitoring data, and the period of the next retrieve requests. The interface computer forwards the first retrieve request to the collection computer at block 309. In response thereto, the collection computer at block 312 adds a new entry for the client into the registration database (using the information extracted from the first retrieve request).

The method then passes to block 315, wherein the collection computer submits a corresponding collection request to all the relevant monitoring agents; the same operation is also performed individually for each monitoring agent whenever the corresponding trigger delay expires. In response thereto, a generic monitoring agent retrieves the desired monitoring data at block 318; for this purpose, in response to the collection request the monitoring agent may either measure the monitoring data directly or provide its latest value (measured periodically using an independent sampling frequency). The process continues to block 321, wherein the monitoring data is returned to the collection computer. Considering now block 324 in the swim-lane of the collection computer, the monitoring data received from the monitoring agent is stored into the central log. The method leads to block 327, wherein the duration of the collection just completed is measured. Continuing to block 330, the period of the retrieve requests (defining the expected time of the next retrieve request) is extracted from the registration database.

The flow of activity now branches at block 333 according to the configuration of the collection computer. Particularly, the time advance for the next collection is calculated at blocks 336-348 (if the collection computer is set to operate in a basic mode) or at blocks 351-363 (if the collection computer is set to operate in an advanced mode). In both cases, the method merges at block 366, wherein the trigger delay is calculated by subtracting the time advance so obtained from the period of the retrieve requests. The method then returns to block 315 for repeating the above-described operations at the expiry of this trigger delay.

Considering now block 336, in the basic mode of operation the statistics database stores the duration of the last collection only; therefore, the last collection duration is replaced with the value measured for the collection that has just completed. The safety margin for the trigger delay is then calculated at block 339; for this purpose, the last collection duration is multiplied by a predefined correction factor (for example, from 0.5 to 1.5 and preferably from 0.7 to 1.2, such 1). A test is made at block 342 to determine whether the safety margin reaches a predefined minimum value. Advantageously, the minimum value is set to a predefined percentage of the period of the retrieve requests (for example, from 1% to 5%, and preferably from 2% to 4%, such as 3%); therefore, typical minimum values will be of the order of a few seconds (when the period is of some tens of seconds). If the above-mentioned condition is not satisfied, the safety margin is set to the minimum value at block 345; the method then continues to block 348. Conversely, the flow of activity descends into block 348 directly. Considering now block 348, the time advance is calculated by adding the safety margin to the last collection duration.

For example, let us consider a generic sequence of retrieve requests with a period of 30s (steps t₋₅ through t₀):

| Retrieve | Collection | Collection | Left | Time | Trigger |
|---|---|---|---|---|---|
| request | delay | duration | time | advance | delay |
| t₀ | 28.00 | 1.00 | 1.00 | 2.00 | 28.00 |
| t₋₁ | 27.00 | 1.00 | 2.00 | 2.00 | 28.00 |
| t₋₂ | 29.00 | 1.50 | (0.50) | 3.00 | 27.00 |
| t₋₃ | 27.00 | 0.50 | 2.50 | 1.00 | 29.00 |
| t₋₄ | 28.00 | 1.50 | 0.50 | 3.00 | 27.00 |
| t₋₅ | 28.00 | 1.00 | 1.00 | 2.00 | 28.00 |

The column “Collection delay” indicates the time between the last retrieve request and the submission of the next collection request (equal to the trigger delay calculated at the preceding step); the column “Collection duration” provides the actual duration of the collection, and the column “Left time” indicates the time between the completion of the collection and the receiving of the corresponding retrieve request. The time advance for the next collection is equal to twice the collection duration (assuming that the safety margin is never lower than the minimum value, for example, 0.5s), while the corresponding trigger delay is calculated subtracting the time advance from the period (30s). As can be seen, when the collection is slow (for example, at step t₋₄) the time advance increases and the trigger delay reduces accordingly (so as to anticipate the next collection request in an attempt to limit the risk of receiving the next retrieve request before the corresponding collection has completed). Conversely, when the collection is fast (for example, at step t₋₃) the time advance reduces and the trigger delay increases accordingly (so as to postpone the next collection request in an attempt to reduce the corresponding left time). However, if the next collection is very slow the corresponding retrieve request can be received before the collection has completed; in this case (as at step t₋₂), the client would receive old monitoring data resulting from the preceding collection.

With reference instead to block 351, in the advanced mode of operation the statistics database stores a predefined set of samples of the preceding collection durations. The number of samples should be enough high to filter out peak values of the collection durations (for example, due to transient phenomena); at the same time, this number should be enough small to respond quickly to significant changes in the collection durations (for example, due to new environmental conditions or normal time-of-day patterns). A good compromise between those opposed requirements consists of setting the number of samples in the range from to 5 to 15, and preferably from 7 to 12, such as 10. In this case, the duration of the collection that has just completed is added to the statistics database (removing the oldest value).

The method then continues to block 354, wherein the mean value μ of the preceding collection durations is calculated:

$$μ = \frac{1}{W} \sum {CD}_{i}$$

(where W is the number of samples, and CDᵢ are the preceding collection durations). Likewise, the corresponding standard deviation σ is calculated at block 357:

$$σ = \frac{1}{W} \sqrt{\sum {( {CD}_{i} - μ )}^{2}}$$

Continuing to block 360, the safety margin is determined multiplying the standard deviation σ by another correction factor n (selected as described in the following). The time advance can now be obtained by adding the safety margin to the mean value μ, i.e., μ+n·σ.

The correction factor n is selected so as to minimize a response time Tr (defined as the time between the completion of the collection of the monitoring data and the corresponding retrieve request) and an ageing time Ta (defined as the time between the start of the collection and the retrieve request). Without any pre-fetching of the monitoring data (i.e., when the collection request is submitted to the monitoring agent in response to the corresponding retrieve request), the mean value of both the response time Tr and the ageing time Ta (denoted with E(Tr) and E(Ta), respectively) would be equal to the mean value μ of the preceding collection durations:
E(Tr)=μ
E(Ta)=μ

Conversely, in order to determine the mean value of the response time Tr and of the ageing time Ta when the monitoring data is pre-fetched, we define a distribution F(t) as the probability that the collection duration CD is lower than the variable t. If we denote the time advance with A, for any value of the variable t the response time Tr is given by:

$$Tr = \{ \begin{matrix}0 : F ( A ) \\ CD - A : 1 - F ( A )\end{matrix}$$

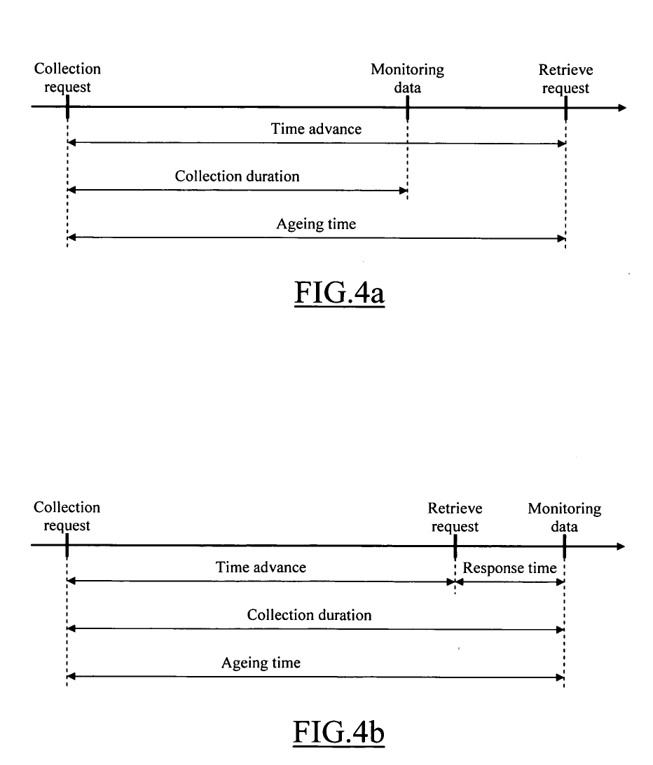

Indeed, as shown in FIG. 4a, when the collection duration CD is lower than the time advance A, i.e., probability F (A), the response time Tr will always be 0 (since the requested monitoring data is already available when the retrieve request is received). Conversely, as shown in FIG. 4b, when the collection duration CD is higher than the time advance A, i.e., probability 1−F(A), the response time Tr will be equal to the residual time (CD−A) required to complete the collection of the monitoring data after receiving the retrieve request.

Likewise, for any value of the variable t the ageing time Ta is given by:

$$Ta = \{ \begin{matrix}A : F ( A ) \\ CD : 1 - F ( A )\end{matrix}$$

Even in this case, as shown in FIG. 4a, when the collection duration CD is lower than the time advance A, i.e., probability F(A), the ageing time Ta will be equal to the time advance A (since the monitoring data is delivered only after receiving the retrieve request); conversely, as shown in FIG. 4b, when the collection duration CD is higher than the time advance A, i.e., probability 1−F(A), the ageing time Ta will be exactly the same as the collection duration CD (since the monitoring data can be delivered immediately).

Therefore, the mean value of the response time Tr and of the ageing time Ta is:
E(Tr)=0·F(A)+[E(t|t>A)−A]·[1−F(A)]=[E(t|t>A)−A]·[1−F(A)]
E(Ta)=A·F(A)+E(t|t>A)·[1−F(A)]
Replacing the time advance A with its value μ+n·σ we have:
E(Tr)=[E(t|t>/μ+n·σ)−μ+n·σ]·[1−F(μ+n·σ)]
E(Ta)=(μ+n·σ)·F(μ+n·σ)+E(t|t>μ+n·σ)·[1−F(μ+n·σ)]
The above-mentioned expressions are minimized when F(μ+n·σ)≈1 (i.e., when the correction factor n is enough high to ensure that the probability of having the collection duration lower than μ+n·σ is substantially 1).

In this case, we have:
E(Tr)≈b 0
E(Ta)≈μ+n·σ=A
Therefore, the mean value of the response time Tr is substantially zero, and then the mean value of the ageing time is the same as the time advance A.

The values of the correction factor n that satisfy the above-mentioned condition, i.e., F(μ+n·σ)≈1, can be calculated assuming a Gaussian distribution of the completion durations CD, so that:

$$F ( t ) = \int \frac{{ⅇ}^{- \frac{{( θ - μ )}^{2}}{2 {σ}^{2}}}}{\sqrt{2 π {σ}^{2}}} ⅆ θ$$

and then:

$$\begin{matrix}F ( μ + n \cdot σ ) = \int \frac{{ⅇ}^{- \frac{{( θ - μ )}^{2}}{2 {σ}^{2}}}}{\sqrt{2 π {σ}^{2}}} ⅆ θ = \frac{1}{2} [ 1 + erf ( \frac{n}{\sqrt{2}} ) ] \\ where erf ( \frac{n}{\sqrt{2}} ) = \frac{2}{\sqrt{π}} \int {ⅇ}^{- \frac{{θ}^{2}}{2}} ⅆ θ .\end{matrix}$$

Therefore, for n=1.3 we have:
n=1: F(μ+n·σ)=0,8385
n=2: F(μ+n·σ)=0,9761
n=3: F(μ+n·σ)=0,9985

In this condition, acceptable performance of the proposed algorithm can be achieved even with low values of the correction factor n (for example, from 1 to 3). Indeed, applying the algorithm to the sequence of retrieve requests considered above (with n=1) we have:

| Retrieve | Collection | Coll. | Left | | | Time | Trigger |
|---|---|---|---|---|---|---|---|
| request | delay | dur. | time | μ | σ | advance | delay |
| t₀ | 28.481670 | 1.00 | 0.518330 | 1.08 | 0.376386 | 1.459720 | 28.540280 |
| t₋₁ | 28.396286 | 1.00 | 0.603714 | 1.10 | 0.418330 | 1.518330 | 28.481670 |
| t₋₂ | 28.500000 | 1.50 | 0.000000 | 1.13 | 0.478714 | 1.603714 | 28.396286 |
| t₋₃ | 28.396447 | 0.50 | 1.103553 | 1.00 | 0.500000 | 1.500000 | 28.500000 |
| t₋₄ | 28.000000 | 1.50 | 0.500000 | 1.25 | 0.353553 | 1.603553 | 28.396447 |
| t₋₅ | 28.000000 | 1.00 | 1.000000 | 1.00 | 1.000000 | 2.000000 | 28.000000 |

Even in this case, the column “Collection delay” indicates the time between the last retrieve request and the submission of the next collection request (equal to the trigger delay calculated at the preceding step); the column “Collection duration” provides the actual duration of the collection, and the column “Left time” indicates the time between the completion of the collection and the receiving of the corresponding retrieve request. The columns “μ” and “σ” indicate the mean value and the standard deviation, respectively, of the available collection durations. The time advance for the next collection is equal to μ+σ, while the corresponding trigger delay is calculated by subtracting the time advance from the period (30s).

As can be seen, the risk of receiving the next retrieve request before the corresponding collection has completed is strongly reduced; at the same time, the waiting time is substantially lowered (of course, at the cost of a higher computational complexity). Particularly, in the example at issue the monitoring data is always received in time irrespective of the fluctuations of the collection durations.

Returning to FIGS. 3a-3c, a next retrieve request is submitted by the client to the interface computer at block 369 (once the corresponding period has elapsed). The interface computer forwards the retrieve request to the collection computer at block 372. In response thereto, the collection computer at block 375 extracts the desired monitoring data from the central log. Continuing to block 378, the monitoring data is then returned to the interface computer immediately. The interface computer in turn relays the monitoring data to the client at block 381. As a result, the monitoring data can be displayed on the client at block 384. The flow of activity then returns to block 369 for repeating the above-described operations continually, until the client decides to stop the monitoring process by sending a corresponding message to the collection computer (through the interface computer).

Naturally, in order to satisfy local and specific requirements, a person skilled in the art may apply to the solution described above many modifications and alterations. Particularly, although the present invention has been described with a certain degree of particularity with reference to preferred embodiment(s) thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a general matter of design choice.

For example, similar considerations apply when other values indicative of the expected time of the next retrieve request and/or of the expected duration of the next collection are determined, and likewise when other values indicative of the time at which the next collection must be triggered are used. For example, it is possible to calculate the expected time of the next retrieve request by adding the known period to the time at which the preceding retrieve request is actually received. In any case, the monitoring data can be delivered in response to different requests (for example, without any preliminary registration) or the monitoring data can be collected in another way; in this respect, it should be noted that although the solution of the invention is specifically designed for an infrastructure working according to the pull paradigm, the use of the devised solution in other environments is not excluded.

Alternatively, the minimum value can be set to a different percentage of the period.

In any case, the programs on the different computers can be structured in another way, or additional modules or functions can be provided; likewise, the different memory structures can be of different types, or can be replaced with equivalent entities (not necessarily consisting of physical storage media). Moreover, the proposed solution can implement an equivalent method (for example, with similar or additional steps).

Similar considerations apply if the infrastructure has a different architecture or it is based on equivalent elements; for example, the clients can access the collection computer directly, or they can be replaced with dumb terminals of the collection computer. Likewise, each computer can have another structure or it can be replaced with any data processing entity (such as a PDA, a mobile phone, a satellite, and the like).

Moreover, it will be apparent to those skilled in the art that the additional features providing further advantages are not essential for carrying out the invention, and may be omitted or replaced with different features.

For example, the time at which the pre-fetching must be started can be determined with different algorithms (generally according to both the expected time of the next retrieve request and the expected duration of the next collection). For example, it is possible to use Linear Predictive Filters (LPFs), filters of higher order or of the Kalman type, and the like.

The solution of the invention is also suitable to be used in applications wherein the retrieve requests are not periodic (using the predictor to recognize patterns of the incoming retrieve requests, so as to estimate the expected time of the next retrieve request).

Alternatively, the time advance can be calculated in a different way (even without any safety margin, when the response time must be limited to the minimum and the risk of receiving old monitoring data in some cases is acceptable).

In the basic mode of operation described above, it is possible to set the correction factor to other values (for example, to values higher then 1 when the risk of receiving the next retrieve request before completing the corresponding collection must be limited to the minimum).

Moreover, the determination of the time advance without any minimum value for the safety margin is contemplated.

Alternatively, the use of a predefined minimum value for the safety margin is within the scope of the invention.

Likewise, in the advanced mode of operation a different number of samples of the preceding collection durations can be used (for example, with a higher number when the capacity of filtering out peak values of the collection durations must be privileged, or with a lower number when the capacity of responding quickly to significant changes in the collection durations is more important).

It is also possible to set the corresponding correction factor to other values (for example, with the correction factor n>3 when the risk of receiving the next retrieve request before completing the corresponding collection must be limited to the minimum).

Even though in the preceding description reference has been made to a monitoring application, this is not to be intended in a limitative manner; indeed, the invention can be applied to deliver any type of information that is collected from one or more source entities (for example, news provided by press agencies, stock exchange lists provided by multiple sites, and the like).

Without departing from the principles of the invention, the programs can be distributed in any other computer readable medium (such as a DVD).

In any case, the proposed solution can be implemented within each managed computer (instead of at the level of the collection computer).

At the end, the method according to the present invention leads itself to be carried out with a hardware structure (for example, integrated in chips of semiconductor material), or with a combination of software and hardware.

1. A method for delivering information in a data processing system in response to repeated requests, the information being collected from at least one source entity each one providing a corresponding type of information, wherein for each source entity the method includes the steps of:
determining an expected request time of a next request of the corresponding information according to the request time of at least one preceding request,
determining an expected collection duration of a next collection of the information from the source entity according to the collection duration of at least one preceding collection, and
collecting the information ahead of the next request according to the expected request time and the expected collection duration.

2. The method according to claim 1, wherein the requests have a predefined period, the step of collecting the information including:
determining a time advance based on the expected collection duration,
calculating a trigger time preceding the expected request time by the time advance, and
starting collecting the information at the expiry of the trigger time.

3. The method according to claim 2, wherein the at least one preceding collection consists of a single preceding collection, the step of determining the expected collection duration including:
setting the expected collection duration to the collection duration of the preceding collection,
and the step of determining the time advance including:
calculating a safety margin multiplying the expected collection duration by a correction factor, and
adding the safety margin to the expected collection duration.

4. The method according to claim 3, wherein the correction factor is between 0.5 and 1.5.

5. The method according to claim 3, wherein the step of determining the time advance further includes:
setting the safety margin to a minimum value when the safety margin is lower than the minimum value.

6. The method according to claim 5, wherein the minimum value is equal to a predetermined percentage of the period.

7. The method according to claim 2, wherein the at least one preceding collection consists of a plurality of preceding collections, the step of determining the expected collection duration including:
setting the expected collection duration to a mean value of the collection durations of the preceding collections, and the step of determining the time advance including:
calculating a standard deviation of the collection durations of the preceding collections,
calculating a further safety margin multiplying the standard deviation by a further correction factor, and
adding the further safety margin to the expected collection duration.

8. The method according to claim 7, wherein the number of preceding collections is between 5 and 15.

9. The method according to claim 7, wherein the further correction factor is between 1 and 3.

10. the method according to claim 1, wherein the information consists of monitoring data relating to operation of the source entity.

11. A program product including a computer readable medium embodying a computer program, the program being directly loadable into a working memory of a data processing system for performing a method for delivering information in response to repeated requests when the program is run on the system, the information being collected from at least one source entity each one providing a corresponding type of information, wherein for each source entity the method includes the steps of:
determining an expected request time of a next request of the corresponding information according to the request time of at least one preceding request,
determining an expected collection duration of a next collection of the information from the source entity according to the collection duration of at least one preceding collection, and
collecting the information ahead of the next request according to the expected request time and the expected collection duration.

12. (canceled)

13. A data processing system for delivering information in response to repeated requests, the information being collected from at least one source entity each one providing a corresponding type of information, wherein for each source entity the system includes:
means for determining an expected request time of a next request of the corresponding information according to the request time of at least one preceding request,
means for determining an expected collection duration of a next collection of the information from the source entity according to the collection duration of at least one preceding collection, and
means for collecting the information ahead of the next request according to the expected request time and the expected collection duration.

14. A data processing infrastructure including the system of claim 13 and at least one source entity each one for providing the corresponding information.

15. A collection computer for delivering information in response to repeated requests, the information being collected from at least one managed computer each one providing a corresponding type of information, wherein the collection computer includes:
a registration structure for determining an expected request time of a next request of each type of information according to the request time of at least one preceding request,
a predictor for determining an expected collection duration of a next collection of each type of information from the corresponding source entity according to the collection duration of at least one preceding collection, and
a monitoring server for collecting each type of information ahead of the corresponding next request according to the expected request time and the expected collection duration.
